(19) United States
(12) Patent Application Publication
(10) Pub. No.: US 2007/0255897 A1
(43) Pub. Date: Nov. 1, 2007

(54) APPARATUS, SYSTEM, AND METHOD FOR FACILITATING PHYSICAL DISK REQUEST SCHEDULING

(76) Inventor: Bruce McNutt, Tucson, AZ (US)

Correspondence Address: Kunzler & McKenzie, 8 EAST BROADWAY, SUITE 600, SALT LAKE CITY, UT, 84111, US

(21) Appl. No.: 11/380,352

(22) Filed: Apr. 26, 2006

(51) Int. Cl. G06F 13/28

(52) U.S. Cl. 711/112

(57) ABSTRACT

A computer program product is disclosed for facilitating physical disk request scheduling. The apparatus is configured to queue disk requests onto a work queue; assign a priority identifier to each disk request in the work queue according to the relative importance of each disk request; determine a ranking index or I/O efficiency for each pending disk request based on the priority of each disk request, the elapsed time on the work queue for each disk request, and the access time calculated for each disk request. The invention has particular applicability to SCSI-3 environments.

### BACKGROUND OF THE INVENTION

1. Field of the Invention

This invention relates to the scheduling of read and write requests to a hard disk and more particularly relates to optimizing the scheduling of read and write operations based on the I/O efficiency value of the disk request compared to the I/O efficiency values of all other pending disk requests.

2. Description of the Related Art

Manufacturers of hard disks and hard disk controllers attempt to design hard disk systems that minimize the average time required to access data on a hard disk. Hard disk systems typically receive requests from a computing device to read data from a disk or to write data to a disk. For purposes of this application, reads from a disk and writes from a disk are both termed disk accesses. A request for a disk access is termed a disk request.

A computing device typically makes disk requests of a hard disk system more rapidly than the hard disk system is able to respond to the disk requests. As a backlog of disk requests builds up, the hard disk system attempts to process all pending disk requests as quickly as possible. Processing the disk requests in a first-in-first-out (FIFO) method ensures that no disk request is favored and that all disk requests are processed sequentially. However, a FIFO approach frequently leads to inefficient disk accesses. To service a disk read request, the disk system must move a disk arm to a position above a disk track on which the data resides. The disk system must also allow the disk to rotate until the data is under the head attached to the disk arm. Frequently, the next disk request in a FIFO queue is not very close to the last disk access. A more optimal disk access may require the servicing of a disk request further down on the queue of pending disk requests based on a shorter access time to a non-FIFO disk request.

The hard disk system may calculate the access time to service each disk request based on the current positioning of the hard disk arm and the hard disk platter. The access time for a given disk request is equal to the time required to move the hard disk arm to the track where data will be accessed plus the amount of time required for the desired data to pass under the disk head. For purposes of this application, the combined time required to move the arm and wait for the rotational positioning of the platter is termed access time.

The disk system may attempt to gain efficiencies by servicing some disk requests out of order based on a preference for minimizing access times. However, such an approach often leads to favoring disk requests in localized sections of a hard disk. Certain disk requests may go unserviced as the disk arm continually services disk requests for a localized and limited number of tracks. This approach may harm system performance, especially in those instances when high priority tasks are not serviced quickly. In addition, such a technique fails to take the priority of I/O requests into account.

From the foregoing discussion, it should be apparent that a need exists for an apparatus, system, and method that determines the ranking of all pending disk requests based on the efficiency value of the individual I/O and then schedules pending disk requests based on the efficiency ranking. Beneficially, such an apparatus, system, and method would minimize disk access times and favor higher priority tasks without starving low priority tasks.

### SUMMARY OF THE INVENTION

The present invention has been developed in response to the present state of the art, and in particular, in response to the problems and needs in the art that have not yet been fully solved by currently available apparatuses, systems, and methods for facilitating physical disk request scheduling. Accordingly, the present invention has been developed to provide an apparatus, system, and method for facilitating physical disk request scheduling that overcome many or all of the above-discussed shortcomings in the art.

The apparatus to facilitate physical disk request scheduling is provided with a plurality of modules configured to functionally execute the necessary steps to facilitate physical disk request scheduling. These modules in the described embodiments include a hard disk controller module, a work queue module, a ranking index module, and a access time module.

The apparatus, in one embodiment, is configured to queue disk requests onto a work queue; assign a priority identifier to each disk request in the work queue according to the relative importance of each disk request; determine access times for each disk request; determine elapsed time on the work queue for each disk request; and calculate a ranking index for each disk request on the work queue based on the priority identifier assigned to each disk request, the access time calculated for each disk, and the elapsed time on the work queue for each disk request.

The apparatus, in one embodiment, is further configured to execute the lowest ranked disk request in the work queue first.

The apparatus, in one embodiment, further comprises a hard disk controller compliant with a Small Computer Systems Interface-3 (SCSI-3) protocol, and wherein each disk request is an application initiated SCSI-3 compliant task having an I_T_L_Q nexus having a SCSI-3 task attribute and a SCSI-3 task priority, and the priority identifier is proportional to the SCSI-3 task priority.

The apparatus, in one embodiment, is further configured such that the priority identifier is equal to the SCSI-3 task priority.

The apparatus, in one embodiment, is further configured such that the hard disk controller decreases the ranking index of disk requests that have waited on the work queue longer than the maximum allowed response time.

The apparatus, in one embodiment, is further configured to calculate the ranking index for each disk request on the work queue establishes such that the ranking index of a given disk request is proportional to the difference between a maximum allowed response time and the elapsed time for a given disk request divided by the maximum allowed response time.

The apparatus, in one embodiment, is further configured such that the ranking index of the given disk request is further proportional to the calculated access time for the given disk request.

The apparatus, in one embodiment, is further configured such that the ranking index of the given disk request is further proportional to the priority identifier of the given disk request.

The apparatus, in one embodiment, is further configured such that the access time for each disk request and the ranking index for each disk request are recalculated each time servicing of a disk request completes.

An apparatus of the present invention is also presented that orders the pending disk requests according to the following formula:
Rᵢ=TᵢPᵢ[(M−Eᵢ)/M]
where Rᵢ is the final ranking of a given disk request;
Eᵢ is the elapsed time since a given disk request was received by the hard disk controller;
Tᵢ is the calculated access time for a given disk request;
M is the maximum allowed response time for a disk request; and
Pᵢ is the SCSI task priority received with the disk request.

A system of the present invention is also presented to facilitate physical disk request scheduling. The system may be embodied as a collection of components of one or more computing devices and modules. In particular, the system, in one embodiment, includes a processor; a random access memory; an operating system running on the processor; a plurality of application programs running under the control of the operating system; a hard disk controller compliant with a Small Computer Systems Interface-3 (SCSI-3) protocol in communication with the processor and the random access memory; a hard disk responsive to the hard disk controller; and a work queue configured to hold pending disk requests from the applications, wherein the hard disk controller orders the pending disk requests on the work queue according to a task priority of a SCSI task identifier assigned to each disk request, a calculated access time for each pending disk request, and the age of each pending disk request.

The system in further disclosed embodiments substantially includes the modules functions presented above with respect to the described apparatus and system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system in accordance with the present invention;

FIG. 2 is a schematic block diagram illustrating one embodiment of a system in accordance with the present invention;

FIG. 3 is a schematic block diagram illustrating one embodiment of a SCSI Task in accordance with the present invention;

FIG. 4 is a schematic block diagram illustrating one embodiment of a hard disk controller in accordance with the present invention; and

FIG. 5 is a schematic flow chart diagram illustrating one embodiment of a method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of being interpreted by a computing device causing execution of a program of machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device. A computer program product may comprise the combination of a computing device and a computer readable medium.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of gone embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

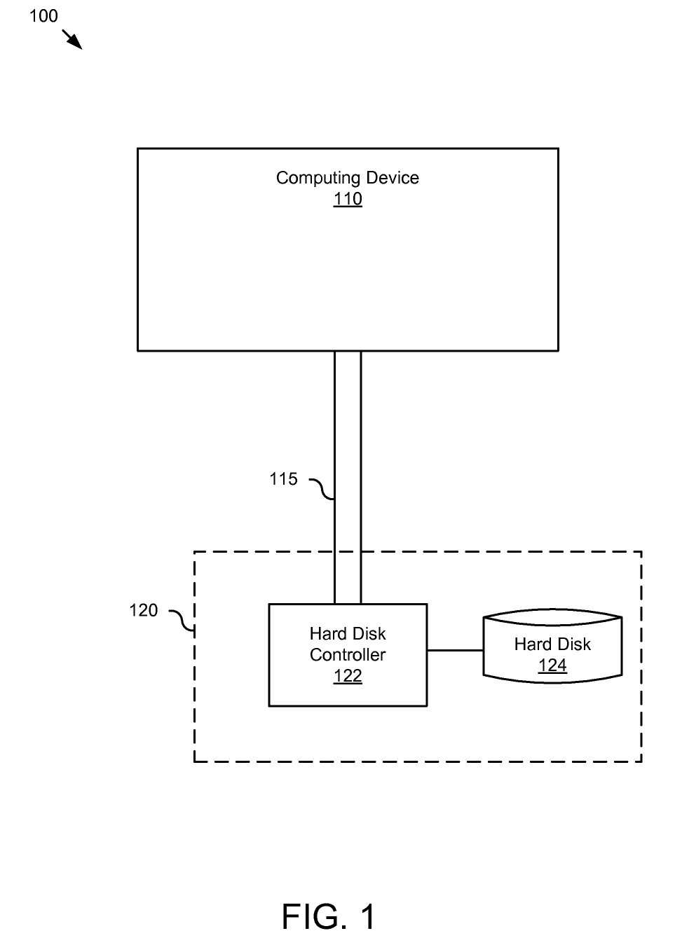

FIG. 1 depicts a system 100 for facilitating physical disk request scheduling by prioritizing and servicing disk requests according to the importance of each disk request. The system 100 may comprise a single CPU or multiple CPUs. A single CPU may access one or more disk systems 120 via one or more communication channels 115. In one embodiment, a plurality of computing devices 110 may access a single disk system 120 through a plurality of communication channels 115. In FIG. 1, a single computing device 110 communicates with a single disk system 120 via a single communication channel 115. However, those of skill in the art could design a system with a plurality of each of the named elements.

The computing device 110 may be a personal computer, a laptop, a mainframe computer, a communications controller, or other device that relies on a disk system 120 for storage. Although the disk system 120 and the communication channel 115 are drawn outside the perimeter of the computing device 110, in some embodiments, the computing device 110 may comprise the disk system 120 and the communication channel 115. FIG. 1 illustrates only one possible embodiment of a system 100.

The computing device 110 uses the communication channel 115 to communicate with the disk system 120. The communication channel 115 provides a data transport mechanism to allow the computing device 110 to read and write data to the disk system 120. The computing device 110 may issue a data read or a data write to the disk system 120. For purposes of this application, data reads and data writes are termed disk accesses and requests for disk accesses are termed disk requests. The computing device 110 communicates over the communication channel 115 using a protocol that allows the computing device 110 to specify a priority level for each disk request. By specifying a priority level, the computing device 110 allows the disk system 120 to use the priority level associated with each disk request in determining the order in which the disk system 120 services disk requests.

The latest proposals for the Small Computer System Interface (SCSI) Architecture Model published by the T10 technical committee provide examples of a communications protocol that allows a computing device to specify a priority level for each disk request. The latest version of the SCSI Architecture Model is currently labeled SAM-3 and has been published by INCITS (InterNational Committee for Information Technology Standards) as standard 402-20005 and is hereby incorporated by reference. A copy of the latest development version of the standard may be obtained at www.t10.org/ftp/t10/drafts/sam3/sam3r14.pdf (hereinafter SAM-3). A published version of the standard may be obtained from various locations including www.techstreet.com/ncitsgate.html as publication 402-2005. In this application the standard is referred to as SAM-3 and the protocol is referred to as the SCSI-3 protocol. The SAM-3 standard and the SCSI-3 protocol support the specification of a task priority for individual disk requests or groups of disk requests as defined in the SAM-3 standard.

In traditional I/O processing schemes, disk requests are processed in FIFO order. However, FIFO processing does not always achieve the most effective disk I/O processing. Alternatively, the priority parameter from the SCSI-3 standard could be used to create a highest priority processing first scheme. Such a processing scheme also fails to achieve the most effective disk I/O processing. The effectiveness of I/O processing can be enhanced, compared with FIFO processing of requests, by determining which disk requests have the highest importance and processing those disk requests first. The most efficient disk request is the disk request that if processed next will achieve the efficient use of the system balanced against the importance of each pending disk request.

The most efficient disk request may be the oldest disk request, may be the highest priority disk request or may be the disk request that has the lowest access time. In all likelihood, the most efficient disk request is determined based on a combination of these three criteria, with no single criteria outweighing the other two in all instances. The priority of a request may be obtained in various ways including from the SCSI-3 standard. Regardless of how it is obtained, simply using disk request importance or priority may starve certain tasks by preventing low priority requests to be serviced. The present invention incorporates specified priority levels with access times and elapsed times for individual disk requests to determine which disk request is the most efficient to service next compared to the other pending disk requests at a given point in time based on the current location of the disk head.

The communication channel 115 provides data transport between the computing device 110 and the disk system 120. The communication channel 115 may be any medium that supports the SAM-3 standard including a SCSI bus, a fibre channel, internet protocol connections, or other data transport media adapted to use the SAM-3 protocol or other protocols that allow specification of priority levels for individual I/O requests.

The disk system 120 comprises a hard disk controller 122 and a hard disk 124. In some embodiments, the disk system 120 may comprise a plurality of hard disk controllers 122 and/or a plurality of hard disks 124. The hard disk controllers 122 of the disk system 120 may be configured in a RAID structure to provide greater protection against hard disk failures. In some embodiments, the disk system 120 serves as secondary storage for the computing device 110 while a random access memory serves as primary storage for the computing device 110.

The hard disk controller 122 may serve as an endpoint for data communication over the communication channel 115. For example, the hard disk controller 122 may be implemented as a SCSI controller communicating over a SCSI bus. Alternatively, the hard disk controller 122 may be implemented as a controller for a fibre channel communication channel 115 or other communication channel 115. The disk system 120 may further comprise a communications controller that handles protocol communication over the communication channel 115 while a hard disk controller 122 handles communication with the hard disk 124.

The hard disk controller 122 maintains a work queue of pending disk requests and executes the disk requests to the hard disk 124 as the hard disk 124 is able to service the disk requests. In one embodiment, the hard disk controller 122 is integrated with the hard disk 124. In another embodiment, the hard disk controller 122 may control a plurality of hard disks 124.

The hard disk 124 comprises one or more disk platters and one or more disk arms. The hard disk controller 122 calculates access times for each pending disk request on the work queue. For purposes of this application, the access time is the total time required to service a disk request. The access time includes the time required to move a disk head attached to a disk arm to the proper position above a track corresponding to the location on the disk for a read or write for a given disk request. The access time further includes the rotational delay or the time for the read or write location to rotate under the head attached to the disk arm. The hard disk controller 122 may calculate the access times for all disk requests on the work queue or for a portion of disk requests on the work queue.

The hard disk controller 122 also tracks the elapsed time that a disk request has waited on the work queue without being serviced. The hard disk controller 122 may also track a priority level or importance for each disk request. The hard disk controller 122 uses the a) calculated access times for each disk request along with b) the priority level or importance assigned to each disk request and c) the elapsed time that each disk request has waited to be serviced to calculate an I/O efficiency value for each disk request. The I/O efficiency value balances the access time for each disk request, the relative value or importance of each disk request, and the delay that each disk request has already experienced. The hard disk controller 122 uses the I/O efficiency values for each disk request to determine which disk request to service next. The I/O efficiency values of each disk request may be recalculated each time that a disk request is executed or serviced.

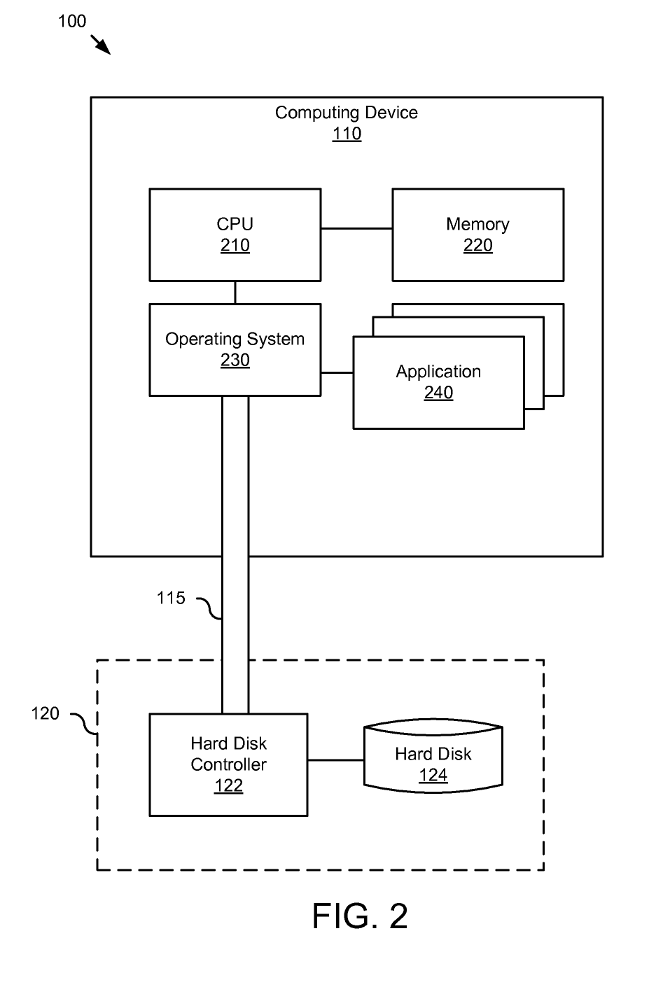

FIG. 2 depicts one embodiment of a system 100 consistent with the present invention. The system 100 comprises a computing device 110, a disk system 120, and a communication channel 115 connecting the computing device 110 to the disk system 120. The computing device 110 may comprise a CPU 210, a random access primary memory 220, an operating system 230, and a plurality of applications 240. Generally, the operating system is stored in the memory 220 and may additionally be stored on a hard disk 124. The operating system 230 may run on the CPU 210. The applications 240 may run as tasks under the control of the operating system 230. Additionally, the operating system 230 may allocate chunks of the memory 220 to each application 240.

The applications 240 may store data on the hard disk 124 and may retrieve data from the hard disk 124. The performance of some applications 240 may be more important than the performance of other applications 240. For example, a system administrator of the computing device 110 may determine that a financial application 240 should have preferential access to the hard disk 124 over a backup application 240. The system administrator may specify through various commands the priority level of each application 240. Alternatively, an application 240 may request or set a higher priority level for itself. Additional means of setting priority levels for the disk requests of individual applications 240 could be designed by those of skill in the art without departing from the spirit of the present invention.

In the illustrated embodiment, the invention allows applications 240 and/or the operating system 230 to affect the I/O efficiency value associated with each disk request and thereby affect the responsiveness of the system 100 to individual applications 240 while continuing to service pending disk requests from all applications 240 in a timely and effective manner.

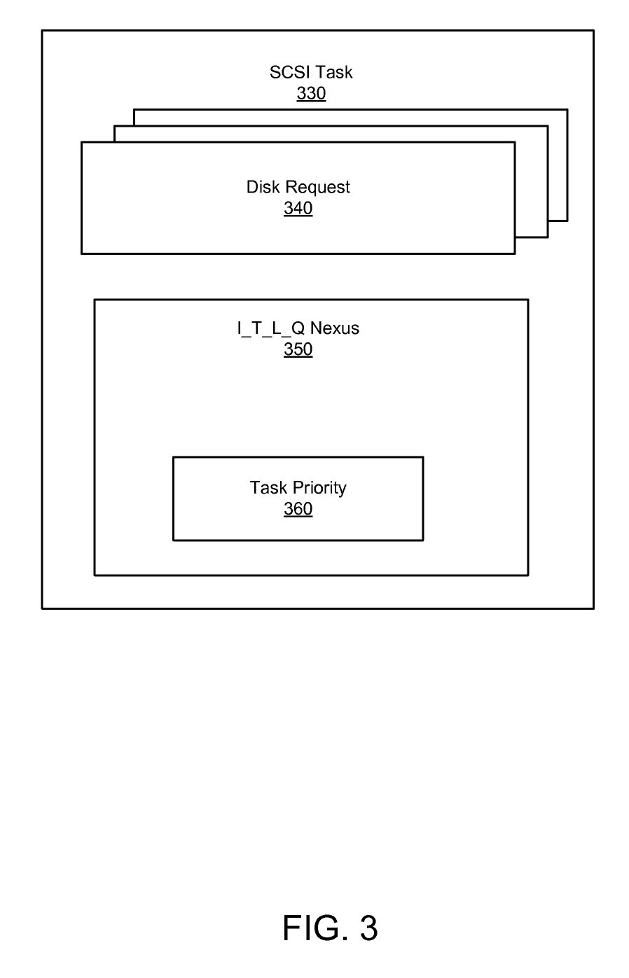

FIG. 3 depicts one embodiment of a SCSI task 330 that supports the specification of a priority level for individual disk requests or sets of disk requests. The illustrated SCSI task 330 is a SCSI task 330 compliant with the SAM-3 standard. Under the SAM-3 standard, requests by an application 240 or by the operating system 230 to access a hard disk 124 may be encoded in a SCSI task 330. A SCSI task 330 may comprise a single disk request or a linked group of disk requests 340, an I_T_L_Q Nexus 350, and a task priority 360. The SCSI task 330 is communicated across the communication channel 115. Each disk request 340 may specify a read or a write to a specific track and sector on the hard disk 124.

Each disk request 340 may comprise a read or write request to a hard disk 124. The I_T_L_Q Nexus 350 comprises an initiator port identifier (I), a target port identifier (T), a logical unit number (L), and a task tag (Q) according to the SAM-3 standard. The I_T_L_Q nexus defines the necessary parameters to allow an operating system 230 to communicate across the communication channel 115. The various port identifiers and the logical unit number uniquely identify the parties to the communication across the communication channel 115. The task tag further defines attributes of the SCSI task 330 such as the task priority 360.

The task priority 360 defines the priority level of the SCSI task 330. The task priority 360 may comprise a four bit unsigned integer that represents the importance of a particular SCSI task 330. In the SAM-3 standard, the four bit value equal to zero is used for default processing. Under SAM-3, task priority 360 ranges from one to fifteen with one being the highest priority or most important and fifteen the lowest or least important. FIG. 3 depicts one embodiment that may be used for assigning task priorities. Those of ordinary skill in the art could define other standards and methods that do not utilize the SAM-3 standard. For instance, a task priority 360 could be assigned an eight bit value or a variable length value without departing from the spirit of the present invention. The task priority 360 may also be termed a priority level or a priority identifier 360.

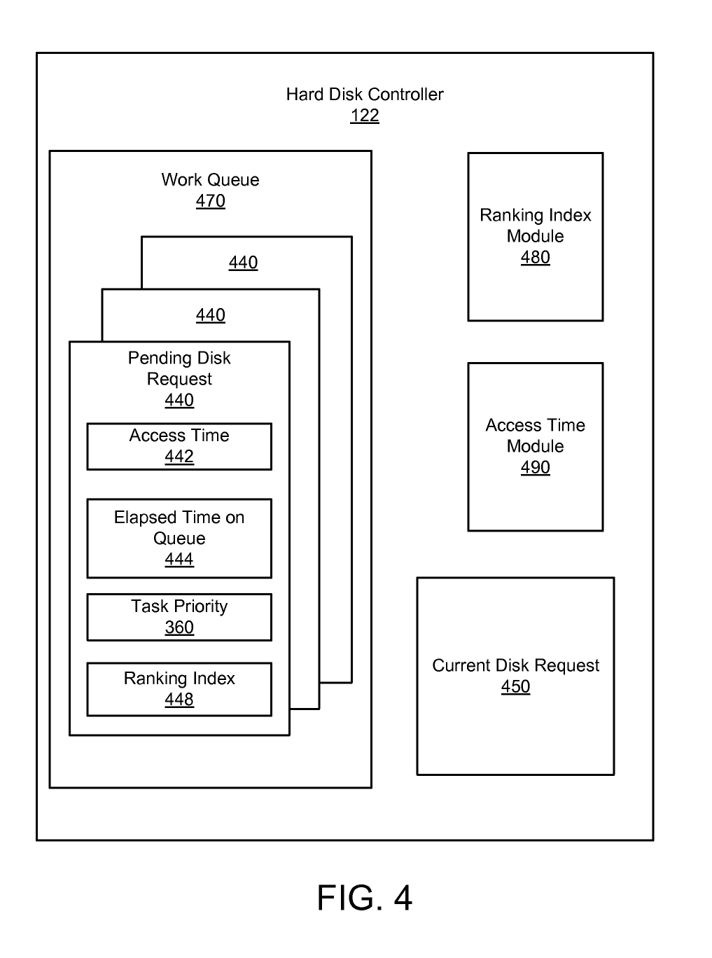

FIG. 4 depicts one embodiment of a hard disk controller 122 consistent with the present invention. The hard disk controller 122 may comprise a work queue 470, a ranking index module 480, an access time module 490, and a current disk request 450.

The work queue 470 maintains a list of the pending disk requests 440. Each SCSI task 330 may comprise one or more commands. Each command corresponds to one pending disk request 440. In one embodiment, a SCSI task 330 received by the hard disk controller 122 and comprising a plurality of commands is broken down into a plurality of pending disk requests 440 stored on the work queue 470. In another embodiment, all of the commands from a single SCSI task 330 are stored on the work queue 470 as a single pending disk request 440.

The ranking index module 480 calculates a ranking index for each pending disk request 440 on the work queue 470. In one embodiment of the hard disk controller 122, the access time module 490 calculates an access time 442 for each pending disk request 440. The ranking index module 480 determines an elapsed time 444 for each pending disk request 440 equal to the time that a given pending disk request 440 has resided on the work queue 470. The ranking index module 480 determines a ranking index 448 for each pending disk request 440 based on the calculated access time 442, the elapsed time 444, and the task priority 360 received with the disk request 340.

In one embodiment, the lowest ranking index is the most important and most efficient disk request to execute next. In another embodiment, the highest ranking index is the most important and most efficient disk request to execute next. Thus, in the embodiment the hard disk controller 122 executes the pending disk request 440 with the lowest ranking index 448 next. In another embodiment, the pending disk request 440 with the highest ranking index 448 is executed next, depending on the whether a high or a low ranking index indicates the most efficient and most important disk request. This application presents a method that executes the pending disk request 440 having the lowest ranking index 448. However, alternative embodiments that execute the highest ranking index could also be created by those of skill in the art. Also, a method that simply repositions the pending disk requests 440 and executes the first pending disk request 440 on an ordered work queue could also be implemented without departing from the spirit of the invention.

As the lowest ranked pending disk request 440 is removed from the work queue 470 for execution, the removed pending disk request 440 becomes the current disk request 450. The hard disk controller 122 moves the disk arm out, or in, such that the hard disk head on the appropriate hard disk arm is over the appropriate track to execute the current disk request 450. The hard disk controller 122 also waits for the disk platter to rotate to bring the desired sector of the track under the disk head. The hard disk controller 122 then causes the disk head to read or write data to the desired sector of the platter.

The access time module 490 may calculate an access time 442 for each pending disk request 440. As described earlier, the access time 442 is equal to the time necessary to service a pending disk request 440. In one embodiment, the access time module 490 calculates the access time 442 for each pending disk request 440 on the work queue 470 assuming a starting position equal to the terminating position of the disk head following the completion of the current disk request 450. In this manner, the access time module 490 calculates an access time 442 for each pending disk request 440 relative to the terminating position of the current disk request 450.

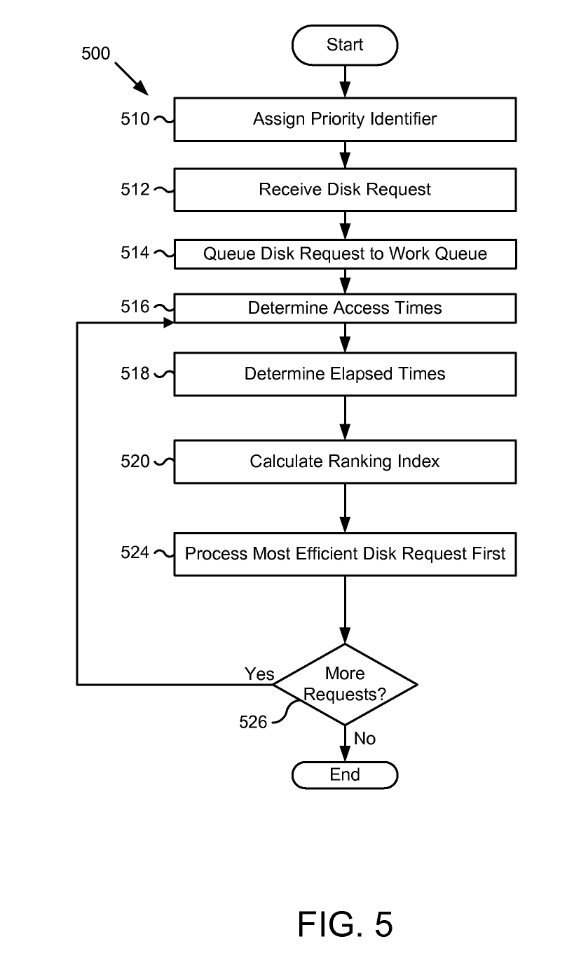

FIG. 5 depicts one embodiment of a method 500 for implementing the present invention. The method 500 comprises assigning 510 a priority identifier to a disk request 340. At the time of the creation of the disk request 340, an operating system 230 or application 240 may assign 510 a priority identifier to the disk request. Alternatively, the hard disk controller 122 may assign 510 a priority identifier to the disk request 340 according to predetermined criteria such as the number of bytes involved in the disk request 340 or the a SCSI source port associated with the disk request 340. In one embodiment, the priority identifier is proportional to or equal to the task priority value of the disk request 340 as specified by the SAM-3 standard.

The method 500 further comprises receiving 512 a disk request 340. A disk request 340 may be issued by an operating system 230, by an application 240, by an operating system 230 on behalf of an application 240, or by another computing entity.

The method 500 further comprises queuing 514 the disk request 340 to the work queue 470 as a pending disk request 440. The access time module 490 determines 516 the access times 442 for each pending disk request 440 on the work queue 470. The access time 442 is calculated relative to the position of the disk arms and the platters when the current disk request 450 is completed.

The ranking index module 480 determines 518 elapsed time 444 for each pending disk request and calculates 520 a ranking index 448 for each pending disk request based on the determined access time 442, the determined elapsed time 444, and the task priority 360 for each pending disk request 440. In one embodiment, the method 500 comprises ordering pending disk requests 440 according to the calculated ranking index 448. The method 500 balances the servicing of disk requests 340 according to the calculated access times 442, the elapsed times 444, and the assigned priority identifier 360.

In one embodiment, I/O efficiency is calculated as a ranking index using the following formula:
Rᵢ=kTᵢPᵢ[(M−Eᵢ)/M]
where Rᵢ is the final ranking index of a given disk request;
Eᵢ is the elapsed time since a given disk request was received by the hard disk controller;
Tᵢ is the access time calculated for a given disk request;
M is the maximum allowed response time for a disk request;
Pᵢ is the task priority according to the SAM-3 standard received with the disk request; and
k is a constant.

Using this formula, the pending disk request 440 with the lowest ranking index Rᵢ has the greatest I/O efficiency and is executed 524 following completion of the current disk request 450. The maximum response time may be predetermined by the manufacturer of the hard disk controller 122 or may be set by the system administrator of the computing system 100. The formula optimizes I/O efficiency by giving preference to pending disk requests 440 whose calculated access times 442 may be lower than the oldest pending disk requests 440 on the work queue 470. In this manner, the hard disk controller 122 opportunistically seeks out pending disk requests 440 that may be easily satisfied and thus increases disk performance. At the same time, the hard disk controller 122 takes into account the amount of time that a pending disk request 440 has sat on the work queue 470 and lowers the ranking index of older pending disk requests 440 proportionately. Finally, the hard disk controller 122 also recognizes that some pending disk requests 440 are more important than others as indicated by the task priority or priority identifier Pᵢ.

The use of this formula in conjunction with a computing device 110, a hard disk controller 122, and a hard disk 124 produces a concrete result, namely that the performance of the disk system 120 is improved by servicing pending disk requests 440 that are easy to service first while allowing for the need to service older pending disk requests 440 and also allowing for the specification of higher priority pending disk requests 440. Taking all of these factors into account increases disk system 120 performance without starving any single type of application.

In an alternative embodiment, the method 500 may use a similar formula to calculate an I/O efficiency value for each pending disk request 440. In
Vᵢ=(αᵢ/Tᵢ)[kM/(M−Eᵢ)]
where Vᵢ is the I/O efficiency value of a disk request or I/O;
Eᵢ is the elapsed time since a given disk request was received by the hard disk controller;
Tᵢ is the access time calculated for a given disk request;
M is the maximum allowed response time for a disk request;
αᵢ is the inverse of the task priority according to the SAM-3 standard received with the disk request or 1/Pᵢ from the prior formula; and
k is a constant.

Advantageously, the Vᵢ method of determining the I/O efficiency value gives an I/O efficiency value that increases with increased importance of the given pending disk request 440. The Rᵢ and the Vᵢ formulas produce the same result, except with the first formula the pending disk request 440 with the lowest Rᵢ is the most efficient and is executed next while the pending disk request 440 with the highest Vᵢ is the most efficient and is executed next.

The method 500 further comprises processing 524 the lowest ranked pending disk request 440 Rᵢ next or, alternatively, the pending disk request 440 with the highest I/O efficiency value Vᵢ. If the hard disk controller 122 determines 526 that more pending disk requests 440 remain on the work queue 470, the hard disk controller 122 then returns to calculating 516 access times 442 for the remaining pending disk requests 440. The method 500 may use the previous rankings to reduce the time needed to calculate ranking indexes 448. However, preferably, the ranking index module 480 does not rely upon previous access time calculations as new access times 442 must be calculated for each pending disk request 440 relative to the ending position of the current disk request 450.

The present invention executes pending disk requests 440 according to the I/O efficiency value of the pending disk requests. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product for scheduling disk requests comprising a computer useable medium including a computer readable program, wherein the computer program product when executed on a computer causes the computer to:
queue each disk request onto a work queue wherein each disk request is assigned a priority identifier according to the relative importance of each disk request;
determine an access time for each disk request, wherein the access time is the time to service the disk request;
determine an elapsed time for each disk request, wherein the elapsed time is the time that has elapsed since the disk request was queued; and
calculate a ranking index for each disk request based on the priority identifier assigned to each disk request, the access time for each disk request, and the elapsed time for each disk request.

2. The computer program product of claim 1, wherein the computer readable program when executed on the computer further causes the computer to execute the most efficient disk request as quantified by the ranking index.

3. The computer program product of claim 2, wherein:
the computer comprises a hard disk controller compliant with a Small Computer Systems Interface-3 (SCSI-3) protocol;
each disk request is an application initiated SCSI-3 compliant task having an I_T_L_Q nexus having a SCSI-3 task attribute and a SCSI-3 task priority; and
the priority identifier is proportional to the SCSI-3 task priority.

4. The computer program product of claim 3, wherein the priority identifier is equal to the SCSI-3 task priority.

5. The computer program product of claim 4, wherein calculating a ranking index favors disk requests whose elapsed time exceeds a maximum allowed response time.

6. The computer program product of claim 4, wherein calculating a ranking index for each disk request on the work queue establishes relative rankings of the disk requests according to a ranking index assigned to each disk request, wherein the ranking index of a given disk request is proportional to the difference between a maximum allowed response time and the elapsed time for a given disk request divided by the maximum allowed response time.

7. The computer program product of claim 5, wherein the ranking index of the given disk request is further proportional to the calculated access time for the given disk request.

8. The computer program product of claim 7, wherein the ranking index of the given disk request is further proportional to the priority identifier of the given disk request.

9. The computer program product of claim 8, wherein the elapsed time for each disk request, the access time for each disk request, and the ranking index for each disk request are recalculated each time servicing of a disk request completes.

10. A system for scheduling disk requests, the system comprising
a processor;
a random access memory;
an operating system running on the processor;
a plurality of application programs running under the control of the operating system;
a hard disk controller compliant with a Small Computer Systems Interface-3 (SCSI-3) protocol in communication with the processor and the random access memory;
a hard disk responsive to the hard disk controller; and
a work queue configured to hold pending disk requests from the applications,
wherein the hard disk controller orders the pending disk requests on the work queue according to a task priority of a SCSI task identifier assigned to each disk request, a calculated access time for each pending disk request, and the age of each pending disk request.

11. The system of claim 10, wherein the hard disk controller orders the pending disk requests using the following formula:
Rᵢ=TᵢPᵢ[(M−Eᵢ)/M]
where Rᵢ is the final ranking of a given disk request;
Eᵢ is the elapsed time since a given disk request was received by the hard disk controller;
Tᵢ is the calculated access time for a given disk request;
M is the maximum allowed response time for a disk request; and
Pᵢ is the SCSI-3 task priority received with the disk request, and wherein the disk request with the lowest Rᵢ value is executed first.

12. The system of claim 10, wherein the operating system receives a disk request from an application and assigns a task priority to the disk request.

13. The system of claim 10, wherein an application running under the control of the operating system calls an operating system service to make a disk request, and wherein the application includes a task priority in the call to the operating system service.

14. The system of claim 10, wherein the calculated access time for a pending disk request predicts the amount of time required to service the pending disk request from the position of the previous disk access.

15. The system of claim 10, wherein the SCSI controller orders the pending disk requests and recalculates access times for all pending disk requests after each disk request is processed.

16. The system of claim 10, wherein the SCSI controller maintains a maximum allowed response time and assigns disk requests that have waited longer than the maximum allowed response time ranking lower than disk requests that have not waited more than the maximum allowed response time.

17. The system of claim 10, wherein the ordering of the pending disk requests establishes relative positions according to a ranking index assigned to each disk request, wherein the ranking index of a given disk request is proportional to the difference between the maximum allowed response time and the elapsed time that the given disk request has spent on the work queue divided by the maximum allowed response time and wherein the ranking index of a given disk request is further proportional to the product of the task priority of the given disk request and the calculated access time of the given disk request.

18. A computer program product for scheduling disk requests comprising a computer useable medium including a computer readable program executable on a hard disk controller, wherein the hard disk controller is compliant with a Small Computer Systems Interface (SCSI) protocol and controls at least one hard disk and receives disk requests via a SCSI communication medium from a computing device, and wherein the computer program product when executed on the controller causes the controller to:
queue each disk request onto a work queue wherein each disk request is assigned a priority identifier proportional to a SCSI-3 task priority received with the disk request;
determine an access time for each disk request, wherein the access time is the time to service the disk request;
determine an elapsed time for each disk request, wherein the elapsed time is the time that has elapsed since the disk request was queued; and
calculate an I/O efficiency value for each disk request based on the priority identifier assigned to each disk request, the access time for each disk request, and the elapsed time for each disk request; and
execute the disk request having the greatest I/O efficiency value first.

19. The computer program product of claim 18, wherein the SCSI-3 task priority is assigned by an operating system that communicates with the hard disk controller.

20. The computer program product of claim 18, wherein the disk request with the most efficient I/O efficiency value has the highest I/O efficiency value and wherein the I/O efficiency value of each disk request is calculated using the following formula:
Vᵢ=(αᵢ/Tᵢ)[kM/(M−Eᵢ)]
where Vᵢ is the I/O efficiency value of a disk request;
Eᵢ is the elapsed time since a given disk request was received by the hard disk controller;
Tᵢ is the access time calculated for a given disk request;
M is the maximum allowed response time for a disk request;
αᵢ is the importance of a pending disk request as found by taking the inverse of the task priority according to the SAM-3 standard received with the disk request or 1/Pᵢ from the prior formula; and
k is a constant.
